(19) United States
(12) Patent Application Publication
(10) Pub. No.: US 2026/0140412 A1
(43) Pub. Date: May 21, 2026

(54) DISPLAY DEVICE

(71) Applicant: LG ELECTRONICS INC., Seoul (KR)

(72) Inventors: Keunsoo LEE, Seoul (KR); Duho JO, Seoul (KR); Hyunil KIM, Seoul (KR); Jeoungoun LEE, Seoul (KR); Sehoon JEONG, Seoul (KR)

(73) Assignee: LG ELECTRONICS INC., Seoul (KR)

(21) Appl. No.: 19/396,961

(22) Filed: Nov. 21, 2025

(30) Foreign Application Priority Data
Nov. 21, 2024 (WO) PCT/KR2024/018461

(51) Int. Cl. G02F 1/1333; F21V 8/00; G02F 1/1335; G02F 1/13357; G02F 1/1339

(52) U.S. Cl. CPC G02F 1/133314; G02B 6/0055; G02F 1/133524; G02F 1/133605; G02F 1/13398

(57) ABSTRACT

A display device is disclosed. The display device includes a display panel; a frame disposed behind the display panel; a light guide plate disposed between the display panel and the frame; a housing comprising a rear part disposed between the light guide plate and the frame and configured to support the rear part and a side part intersecting the rear part and facing one side of the light guide plate; a substrate disposed between the side part and the one side of the light guide plate and coupled to the side part; a light source disposed on the substrate and providing light toward the one side of the light guide plate; and a spacer comprising a support disposed around the light source and coupled to the substrate and a projecting wall extending from the support and disposed behind the light guide plate.

### CROSS-REFERENCE TO RELATED APPLICATION

Pursuant to 35 U.S.C. § 119, this application claims the benefit of earlier filing date and right of priority of International Application No. PCT/KR2024/018461, filed on Nov. 21, 2024, the contents of which are all incorporated by reference herein in its entirety.

### BACKGROUND OF THE INVENTION

### Field of the invention

The present disclosure relates to a display device.

### Description of the Related Art

With the development of information society, demand for various kinds of display devices is increasing. In response to this demand, various kinds of display devices, such as LCDs (Liquid Crystal Displays), PDPs (Plasma Display Panels), ELDs (Electro-luminescent Displays), VFDs (Vacuum Fluorescent Displays) and OLEDs (Organic Light-Emitting Diodes) have been recently researched and used.

Thereamong, an LCD panel includes a TFT substrate and a color substrate, which face each other with a liquid crystal layer interposed therebetween, in order to display an image using light supplied from a backlight unit. In recent years, a great deal of research on a structure configured to protect the light source of an edge-lighting-type LCD in which the light source is disposed at the periphery of the display device is being conducted.

### SUMMARY OF THE INVENTION

It is an object of the present disclosure to solve the above and other problems.

Another object of the present disclosure may be to provide a structure in which the light source of a backlight unit is spaced apart from a light guide plate.

Another object of the present disclosure may be to provide a structure configured to prevent collision of the light source of the backlight unit with the light guide plate.

Another object of the present disclosure may be to provide a structure configured to stably support the light guide plate.

Another object of the present disclosure may be to provide a structure configured to prevent misalignment of the light source of the backlight unit with the light guide plate.

Another object of the present disclosure may be to provide a structure configured to prevent the light guide plate from being bent.

In order to accomplish the above and other objects, a display device according to one aspect of the present disclosure may include a display panel; a frame disposed behind the display panel; a light guide plate disposed between the display panel and the frame; a housing comprising a rear part disposed between the light guide plate and the frame so as to support the rear part and a side part intersecting the rear part and facing one side of the light guide plate; a substrate disposed between the side part and the one side of the light guide plate and coupled to the side part; a light source disposed on the substrate and emitting light toward the one side of the light guide plate; and a spacer comprising a support disposed around the light source and coupled to the substrate and a projecting wall extending from the support and disposed behind the light guide plate.

### BRIEF DESCRIPTION OF THE DRAWINGS

The above and other objects, features and other advantages of the present disclosure will be more apparent from the following detailed description in conjunction with the accompanying drawings, in which:

FIGS. 1 to 16 are diagrams illustrating examples of a display device according to embodiments of the present disclosure.

### DETAILED DESCRIPTION

A description will now be given in detail according to exemplary embodiments disclosed herein, with reference to the accompanying drawings. For the sake of brevity of description with reference to the drawings, the same or equivalent components are denoted by the same reference numbers, and a description thereof will not be repeated.

In general, suffixes such as “module” and “unit” may be used to refer to elements or components. The use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to facilitate understanding of various technical features, and it should be understood that the embodiments presented herein are not limited by the accompanying drawings. As such, the present disclosure should be construed to extend to any alterations, equivalents and substitutes, in addition to those that are particularly set out in the accompanying drawings.

It is to be understood that, although the terms “first,” “second,” etc. may be used herein to describe various elements, these elements should not be limited by these terms. These terms are only used to distinguish one element from another.

It will be understood that when an element is referred to as being “connected to” another element, intervening elements may be present. In contrast, it will be understood that when an element is referred to as being “directly connected to” another element, there are no intervening elements present.

A singular representation may include a plural representation unless the context clearly indicates otherwise.

In the present disclosure, it should be understood that the terms “comprises,” “includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

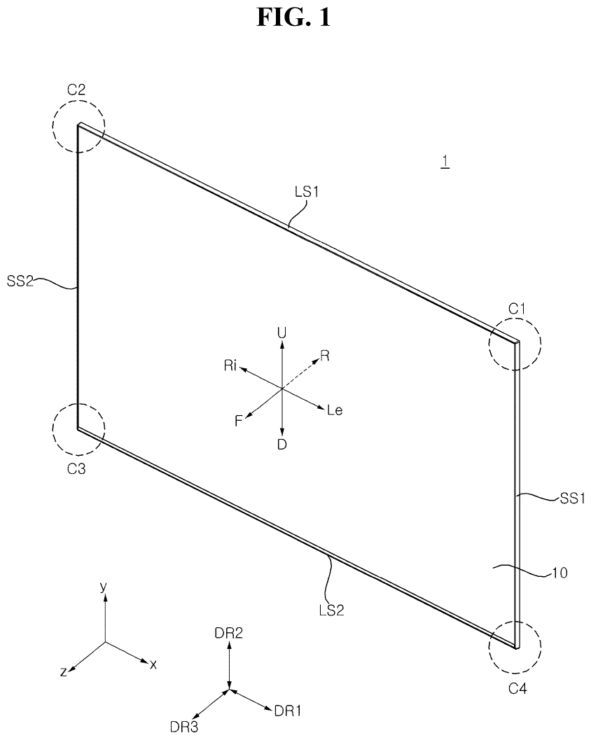

Referring to FIG. 1, the display device 1 may include a display 10. The display 10 may display an image.

The display device 1 may include a first long side LS1, a second long side LS2 opposed to the first long side LS1, a first short side SS1 adjacent to the first long side LS1 and the second long side LS2, and a second short side SS2 opposed to the first short side SS1. Although each of the first and second long sides LS1 and LS2 is illustrated and described as being longer than each of the first and second short sides SS1 and SS2 for convenience of explanation, the length of each of the first and second long sides LS1 and LS2 may be almost equal to that of each of the first and second short sides SS1 and SS2.

A direction parallel to the first and second long sides LS1 and LS2 of the display device 1 may be referred to as a lateral direction or a first direction DR1. A direction parallel to the first and second short sides SS1 and SS2 of the display device 1 may be referred to as a vertical direction or a second direction DR2. A direction perpendicular to the first and second long sides LS1 and LS2 and the first and second short sides SS1 and SS2 of the display device 1 may be referred to as a forward/backward direction or a third direction DR3.

A direction in which the display panel 10 displays an image may be referred to as forward F or z, and the opposite direction may be referred to as rearward R. The first long side LS1 may be referred to as an upper side U or y, and the second long side LS2 may be referred to as a lower side. The first short side SS1 may be referred to as a left side Le or x, and the second short side SS2 may be referred to as a right side Ri.

The first long side LS1, the second long side LS2, the first short side SS1 and the second short side SS2 may be referred to as an edge of the display device 1. The points at the first long side LS1, the second long side LS2, the first short side SS1 and the second short side SS2 meet each other may be referred to as corners.

For example, the point at which the first short side SS1 and the first long side LS1 meet each other may be referred to as a first corner C1. The point at which the first long side LS1 and the second short side SS2 meet each other may be referred to as a second corner C2. The point at which the second short side SS2 and the second long side LS2 meet each other may be referred to as a third corner C3. The point at which the second long side LS2 and the first short side SS1 meet each other may be referred to as a fourth corner C4.

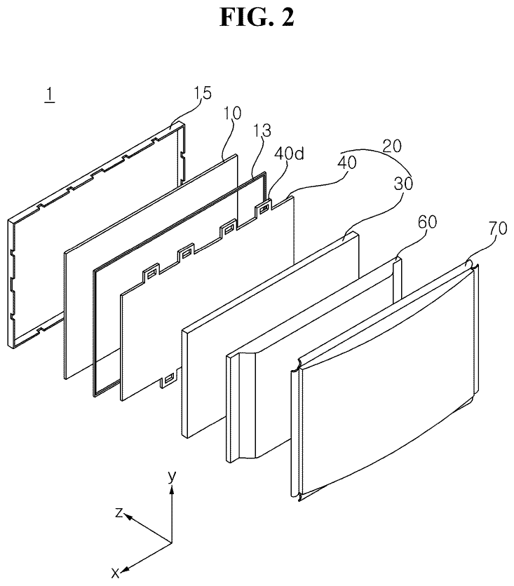

Referring to FIG. 2, the display device 1 may include the display panel 10, a print cover 15, a guide panel 13, a backlight unit 20, a frame 60, and a back cover 70.

The display panel 10 may define the front face of the display device 1 so as to display an image. The display panel 10 may display an image by outputting red, green or blue of each of a plurality of pixels at specific times. The display panel 10 may be divided into an active area, in which an image is displayed, and an inactive area, in which an image is not displayed. The display panel 10 may include a front substrate and a rear substrate, which face each other with a liquid crystal layer interposed therebetween. The display panel 10 may be referred to as an LCD.

The front substrate may include a plurality of pixels, each of which is composed of red, green and blue sub-pixels. The front substrate may output light corresponding to red, green or blue in response to a control signal.

The rear substrate may include switching devices. The rear substrate may switch a pixel electrode. For example, the pixel electrode may change the molecular arrangement of the liquid crystal layer in response to a control signal. The liquid crystal layer may include liquid crystal molecules. The arrangement of the liquid crystal molecules may be changed according to the voltage difference between the pixel electrode and the common electrode. The liquid crystal layer may transmit the light supplied from the backlight unit 20 to the front substrate, or may obstruct the transmission of light.

The front cover 15 may cover a portion of the front surface and the lateral surface of the display panel 10. The front cover 15 may be divided into a front cover disposed on the front surface of the display panel 10 and a lateral cover disposed on the lateral surface of the display panel 10. The front cover and the lateral cover may be separately constructed or integrally constructed. At least one of the front cover or the lateral cover may be omitted.

The guide panel 13 may surround the periphery of the display panel 10 and may cover the lateral surfaces of the display panel 10. The guide panel 13 may be coupled to the display panel 10 or may support the display panel 10. The guide panel 13 may be referred to as a “panel guide 13” or a “side frame 13”.

The backlight unit 20 may be positioned behind the display panel 10. The backlight unit 20 may include light sources. The backlight unit 20 may be positioned in the front of the frame 60, and may be coupled to the frame 60. The backlight unit 20 may be driven in a whole area driving manner or in a local area driving manner, such as local dimming driving or impulse driving. The backlight unit 20 may include an optical sheet 40 and an optical layer 30.

The optical sheet 40 may uniformly transmit the light from the light sources to the display panel 10. The optical sheet 40 may be composed of a plurality of layers. For example, the optical sheet 40 may include a prism sheet, a diffusion sheet and the like. Meanwhile, a coupler 40d of the optical sheet 40 may be coupled to the front cover 15, the frame 60 or the back cover 70.

The frame 60 may be positioned behind the backlight unit 20 so as to support the components of the display device 1. For example, components such as the backlight unit 20 and a printed circuit board (PCB), on which a plurality of electronic components are positioned, may be coupled to the frame 60. The frame 60 may include a metal such as an aluminum alloy. The frame 60 may be referred to as a “main frame” or a “module cover”.

The back cover 70 may cover the rear surface of the frame 60. The back cover 70 may be coupled to the frame 60 and/or the front cover 15. For example, the back cover 70 may be produced through injection-molding of a resin. In another embodiment, the back cover 70 may include a metal material.

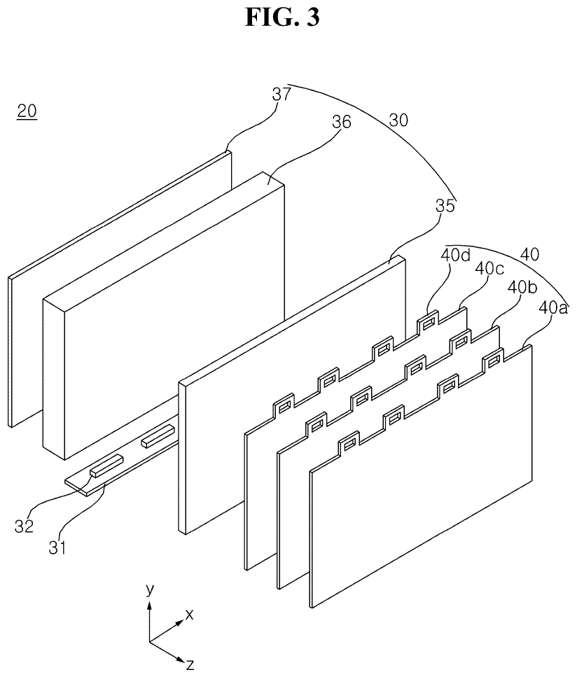

Referring to FIG. 3, the optical layer 30 may include a substrate 31, at least one light assembly 32, a reflective sheet 37, and a light guide plate 36. The optical sheet 40 may be positioned in front of the optical layer 30. The light assembly 32 may be referred to as a “light source 32” or a “plurality of light sources 32.

The substrate 32 may extend in a rightward-and-leftward direction and may be disposed adjacent to the periphery of the light guide plate 36. For example, the substrate 31 may be disposed adjacent to the lower side of the light guide plate 36. At least a light assembly 32 may be mounted on the substrate 31. In other words, the light source of the backlight unit 20 may be disposed on the edge of the backlight unit 20. An electrode pattern may be formed at the substrate 31 so as to connect an adaptor to the light assembly 32. For example, the electrode pattern may be a carbon nanotube electrode pattern. The substrate 31 may be composed of at least one of polyethylene terephthalate (PET), glass, polycarbonate (PC) or silicon. The substrate 32 may be a printed circuit board (PCB) on which at least one light assembly 32 is mounted.

The light assembly 32 may be a light-emitting diode (LED) chip or a light-emitting diode package including at least one light-emitting diode chip. The light assembly 32 may be composed of a colored LED configured to emit at least one color among red, green and blue or a white color LED. The colored LED may include at least one of a red LED, a green LED or a blue LED.

The light guide plate 36 may be disposed behind the optical sheet 40. Most of the light supplied from the light assembly 32 may be transmitted to the inside of the light guide plate 36. The light guide plate 36 may reflect the light, transmitted from the light assembly 32, forwards.

The reflective sheet 37 may be disposed behind the light guide plate 36. The reflective sheet 37 may reflect the light, which is supplied from the light assembly 32 or reflected by the light guide plate 36, forwards. For example, the reflective sheet 37 may include metal and/or metal oxide having high reflectance, such as at least one of aluminum (Al), silver (Ag), gold (Au) or titanium dioxide (TiO2).

The light sheet 40 may include at least one sheet. For example, the optical sheet 40 may include one or more prism sheets and/or one or more diffusion sheets. The plurality of sheets of the optical sheet 40 may be attached to each other or be in close contact with each other.

Specifically, the optical sheet 40 may be composed of a plurality of sheets which have different functions. For example, the optical sheet 40 may include a first optical sheet 40a, a second optical sheet 40b and a third optical sheet 40c. For example, the first diffusion sheet 40a may be a diffusion sheet, and the second optical sheet 40b and the third optical sheet 40c may be prism sheets. The diffusion sheet may prevent the light exiting from the diffusion plate 35 from being locally concentrated, thus providing more uniformly distributed light. The prism sheet may collect the light exiting from the diffusion sheet 35 and may provide the light to the display panel 10. The number and/or position of the diffusion sheets and the prism sheets may be changed.

The optical layer 30 may include the diffusion sheet 35 disposed between the light guide plate 36 and the optical sheet 40.

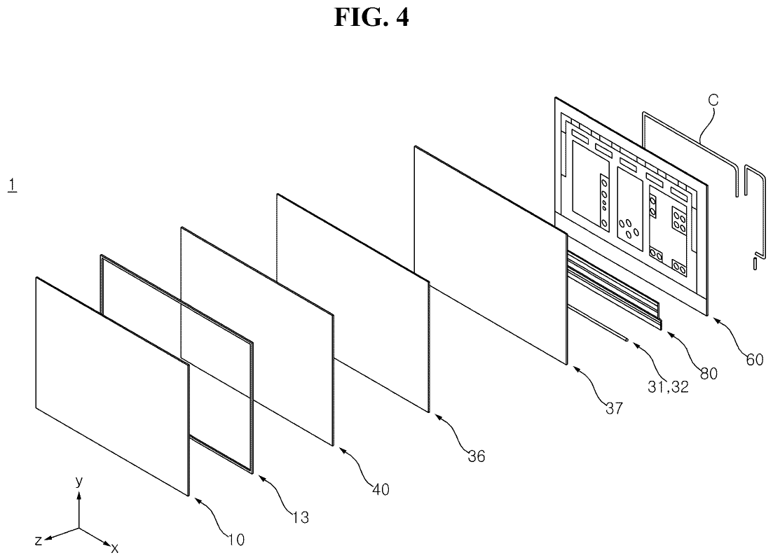

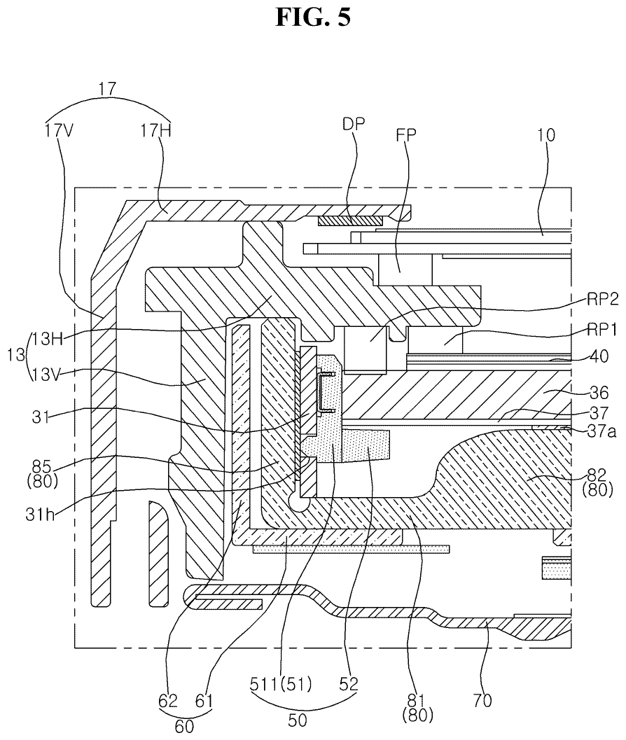

Referring to FIGS. 4 and 5, the frame 60 may include a flat plate portion 61 and a bent portion 62. The flat plate portion 61 may define the front surface of the frame 60 and may be generally flat. The bent portion 62 may be bent forwards at the periphery of the flat plate portion 61 and may extend along the periphery of the flat plate portion 61.

The housing 80 may be disposed on the flat plate portion 61. The housing 80 may be disposed adjacent to the lower side of the frame 60. The housing 80 may include a rear part 81 and a side part 85. The rear part 81 may be coupled or fixed to the flat plate portion 61. The side part 85 may be bent forwards at the lower end of the rear part 81.

The housing 80 may include a projection 82 projecting forwards from the front surface of the rear part 81. The side part 85 may project forwards farther than the projection 82. The side part 85 may be disposed between the bent portion 62 and the projection 82 and may be spaced apart from the bent portion 62 and the projection 82. The housing 80 may include a metal material such as aluminum (Al). The housing 80 may be referred to as a “head sink 80”.

The guide panel 13 may include a vertical portion 13V and the horizontal portion 13H. The vertical portion 13V may extend along the bent portion 62 and may cover the outer side of the bent portion 62. The horizontal portion 13H may intersect the vertical portion 13V and may cover a portion of the front side of the housing 80.

The light guide plate 36 may be disposed between the horizontal portion 13H and the projection 82. The reflective sheet 37 may be coupled to the rear surface of the light guide plate 36. A pad 37a may be disposed between the reflective sheet 37 and the projection 82 and may be attached to the projection 82. The optical sheet 40 may be disposed on the front surface of the light guide plate 36. The portion of the rear surface of the light guide plate 36 adjacent to the lower side of the light guide plate 36 may be supported by the projection 82. The portions of the rear surface of the light guide plate 36 adjacent to the upper side, the left side and the right side of the light guide plate 36 may be supported by the frame 60.

The display panel may face the optical sheet 40 with the horizontal portion 13H interposed therebetween. A front pad FP may be disposed between the display panel 10 and the horizontal portion 13H and may be coupled to the horizontal portion 13H. A first rear pad RP1 may be disposed between the horizontal portion 13H and the optical sheet 40 and may be coupled to the horizontal portion 13H. A second rear pad RP2 may be disposed between the horizontal portion 13H and the light guide plate 36 and may be coupled to the horizontal portion 13H.

An end frame 17 may include a first part 17V and a second part 17H. The first part 17V may extend along the vertical portion 13V and may cover the outer side of the vertical portion 13V. The second part 17H may intersect the first part 17V and may cover a portion of the front sides of the guide panel 13 and the display panel 10. A pad DP may be disposed between the second part 17H and the display panel 10 and may be coupled to the second part 17H.

A cable C (see FIG. 4) may be electrically connected to the display panel 10 and a source PCB (Source Printed Circuit Board, not shown). The cable C (see FIG. 4) may pass between the guide panel 13 and the end frame 17 and may be connected to the source PCB (not shown) at the rear side of the frame 60. For example, the cable C (see FIG. 4) may be an FFC (Flexible Flat Cable).

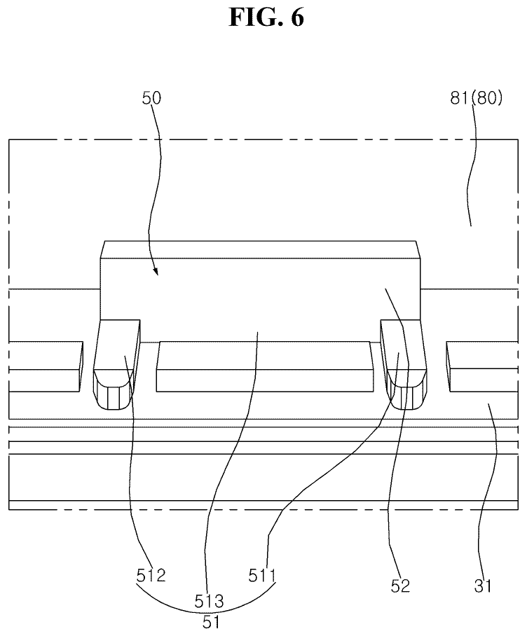

Referring to FIGS. 5 and 6, the substrate 31 may be disposed on the side part 85 of the housing 80. The substrate 31 may extend along the lower side of the light guide plate 36. A plurality of light sources 32 may be disposed on the substrate 31.

A spacer 50 may be disposed on the substrate 31. The spacer 50 may be disposed around the plurality of light sources 32 so as to space the plurality of light sources 32 apart from each other. Supports 511 and 512 of the spacer 50 may be in contact with the substrate 41 and may be disposed between the plurality of light sources 32. The supports 511 and 512 may support the lower side of the light guide plate 36. A projecting wall 52 of the spacer 50 may project from the supports 511 and 512 and may be disposed between the light guide plate 36 and the rear part 81 of the housing 80. The projecting wall 52 may be disposed adjacent to the rear surface of the light guide plate 36. Consequently, when the light guide plate 36 expands due to heat or the like, the projecting wall may prevent the lower end of the light guide plate 36 from being bent rearwards or being misaligned with the light sources and may prevent deterioration of photoelasticity. The spacer 50 may be referred to as a “guard 50”, a “pad 50”, a “protector 50” or a “barrier 50”. For example, the spacer 50 may be produced through injection-molding of resin or silicone.

The spacer 50 may be disposed on the substrate 31 between the substrate 31 and the projection 82. The spacer 50 may include a base 51 in contact with the substrate 31. The base 51 may have a general U shape. The base 51 may include the first support 511 and the second support 512 which extend in a forward-and-rearward direction and may include a bridge 513 connecting the end of the first support 511 and the end of the second support 512. The first support 511 may be disposed between the plurality of light sources 32. The second support 512 may be disposed between the plurality of light sources 32 and may be spaced rightwards apart from the first support 511. The bridge 513 may extend in a rightward-and-leftward direction and may connect the rear end of the first support 511 to the rear end of the second support 512. At least one of light source 32 is disposed between the first support 511 and the second support 512. The base 51 may surround at least a portion of the light source 32. Specifically, the base 51 may surround the right and left lateral surfaces and the rear surface of the light source 32. The first support 511 may be referred to as a “first leg”, and the second support 512 may be referred to as a “second leg”.

The projecting wall 52 may extend upwards from the base 51. Specifically, the projecting wall 52 may project upwards from the bridge 513, the rear end of the first support 511 and the rear end of the second support 512. The projecting wall 52 may be referred to as a “projection 52” or a “rack”.

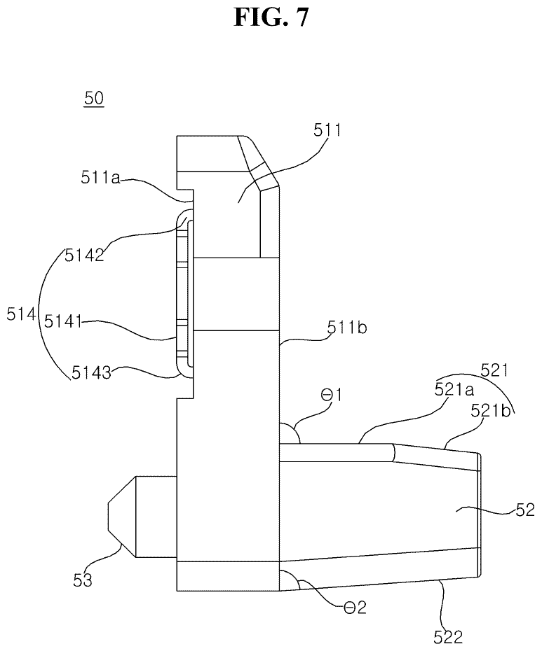

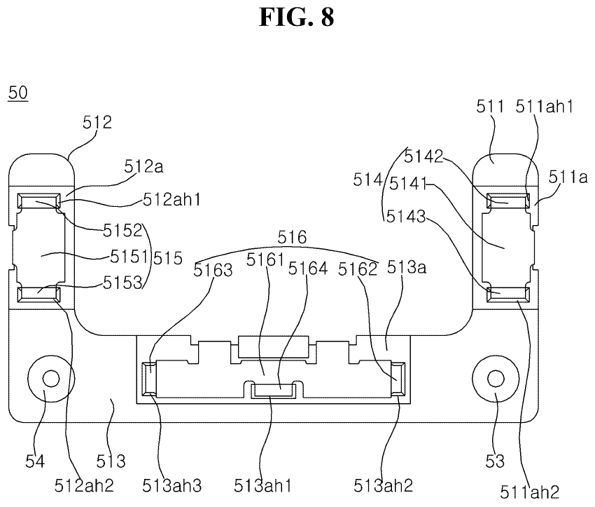

Referring to FIGS. 6 to 8, the base 51 may include depressed portions 511a, 512a and 513a depressed from the surface of the base 51 that faces the substrate 31. The depressed portions 511a, 512a and 513a may have a height difference with respect to the surface of the base 51. The depressed portions 511a, 512a and 513a may include a plurality of insertion grooves 511ah1, 511ah2, 512ah1, 5123ah2, 513ah2, 513ah1, 513ah2 and 513ah3.

The spacer 50 may include dampers 514, 515 and 516 which are disposed in the depressed portions 511a, 512a and 513a. The dampers 514, 515 and 516 may include plate-shaped first parts 5141, 5151 and 5161, second parts 5141, 5152 and 516 2 which are bent at edges of the first parts 5141, 5151 and 5161, and third parts 5143, 5153 and 5163 which are bent at edges of the first parts 5141, 5151 and 5161. The second parts 5142, 5152 and 5162 and the third parts 5143, 5153 and 5163 may be respectively inserted into the insertion grooves 511ah1, 511ah2, 512ah1, 512h2, 513ah1, 513ah2 and 513ah3 formed in the depressed portions 511a, 512a and 513a. The first parts 5141, 5151 and 5161 may be spaced apart from the depressed portions 511a, 512a and 513a and may be parallel to the surface of the base 51 that faces the substrate 31. The dampers 514, 515 and 516 may be made of an elastic material. Therefore, the dampers 514, 515 and 516 may absorb impact applied to the spacer 50.

Specifically, the first support 511 may include a first depressed portion 511a depressed from the lower surface thereof, and a first insertion groove 511ah1 and a second insertion groove 511ah2 may be formed in the first depressed portion 511a so as to be depressed upwards. The first insertion groove 511ah1 may be spaced forwards apart from the second insertion groove 511ah2. A first damper 514 may be disposed in the first depressed portion 511a. The first damper 514 may include a plate-shaped first part 5141 which extends in a forward-and-rearward direction, a second part 5142 which is bent upwards at the rear end of the first part 5141 and is inserted at a portion thereof into the first insertion groove 511ah1, and a third part 5143 which is bent upwards at the rear end of the first part 5141 and is inserted at a portion thereof into the second insertion groove 511ah2. The first part 5141 of the first damper 513 may be spaced downwards apart from the first depressed portion 511a and may be in contact with the substrate 31. Accordingly, even when downward impact is applied to the upper surface 511b of the first support 511, the first damper 514 may absorb the impact.

The second support 512 may include a second depressed portion 512a depressed from the lower surface thereof, and a third insertion groove 512ah1 and a fourth insertion groove 512ah2 may be formed in the second depressed portion 512a so as to be depressed upwards. The third insertion groove 512ah1 may be spaced forwards apart from the fourth insertion groove 512ah2. A second damper 515 may be disposed in the second depressed portion 512a. The second damper 515 may include a plate-shaped first part 5151 which extends in a forward-and-rearward direction, a second part 5152 which is bent upwards at the front end of the first part 5151 and is inserted at a portion thereof into the third insertion groove 512ah1, and a third part 5153 which is bent upwards at the rear end of the first part 5151 and is inserted at a portion thereof into the fourth insertion groove 512ah2. The first part 5151 of the second damper 515 may be spaced downwards apart from the second depressed portion 512a and may be in contact with the substrate 31. Accordingly, even when downward impact is applied to the upper surface 512b of the second support 512, the second damper 515 may absorb the impact.

The bridge 513 may include a third depressed portion 513a depressed from the lower surface of the bridge 513, and a fifth insertion groove 513ah1, a sixth insertion groove 513ah2 and a seventh insertion groove 513ah3 may be formed in the third depressed portion 513a so as to be depressed upwards. The fifth insertion groove 513ah1 may be positioned in the center of the bridge 513 in the rightward-and-leftward direction, the sixth insertion groove 513ah2 may be spaced leftwards apart from the fifth insertion groove 513ah1, and the seventh insertion groove 513ah3 may be spaced rightwards apart from the fifth insertion groove 513ah1. A third damper 516 may be disposed in the third depressed portion 513a. The third damper 516 may include a plate-shaped first part 5161 which extends in a rightward-and-leftward direction, a second part 5162 which is bent upwards at the left end of the first part 5161 and is inserted at at least a portion thereof into the sixth insertion groove 513ah2, a third part 5163 which is bent upwards at the right end of the first part 5161 and is inserted at at least a portion thereof into the seventh insertion groove 513ah3, and a fourth part 5164 which is bent upwards at a portion of the rear end of the first part 5161 and is inserted into the fifth insertion groove 513ah1. The first part 5161 of the third damper 516 may be spaced apart from the third depressed portion 513a and may be in contact with the substrate 31. Accordingly, even when downward impact is applied to the base 51, the third damper 516 may absorb the impact.

The spacer 50 may include protrusions 54 and 54 projecting from the base 51. The protrusions 53 and 54 may project toward the base 51 in the opposite direction of the projecting wall 52 and may be inserted into a hole 31h (see FIG. 5) in the substrate 31. The protrusions 53 and 54 may be referred to as “bosses 53 54”. Each of the protrusions 53 and 54 is inserted into the hole 31h formed in the substrate 31 and may be soldered to thereto, thereby fixing the spacer 50 to the substrate 31. The spacer 50 may be coupled to the substrate 31 in a PTH (Plated Through Hole) manner such that each of the protrusions 53 and 54 is inserted into the hole 31h (see FIG. 5) and fixed thereto. Alternatively, the spacer 50 may be coupled to the substrate 31 using SMT (Surface Mount Technology).

Specifically, the spacer 50 may include a first protrusion 53 which is disposed adjacent to the rear end of the first support 511 and projects downwards from the base 51 and a second protrusion 54 which is disposed adjacent to the rear end of the second support 512 and projects downwards from the base 51. The first protrusion 53 and the second protrusion 54 may be respectively inserted into the plurality of holes 31h (see FIG. 5) which are formed in the substrate 31 at positions spaced apart from each other, with the result that the spacer 50 is fixed to the substrate 31. The protrusion 53 and 54, which are inserted into the holes 31h (see FIG. 5) of the substrate 31, may be more firmly fixed to the substrate 31.

Referring to FIGS. 5 to 7 together, the upper surface 511b of the first support 511 which is one surface 511b that faces the light guide plate 36 of the first support 511 may be flush with the upper surface 512b of the second support 512 which is one surface that faces the light guide plate 36 of the second support 512. The upper surface 511b of the first support 511 and the upper surface 512b of the second support 512 may be collectively referred to as “upper surfaces 511b and 512b of the supports 511 and 512.

The upper surfaces 511b and 512b of the supports 511 and 512 may be parallel to the substrate 31. At least a portion of a projecting wall supporting surface 521 of the spacer 50 that faces the light guide plate 36 may be perpendicular to the upper surfaces 511b and 512b of the supports 511 and 512. Specifically, the projecting wall supporting surface 521 may include a vertical portion 521a and a sloping portion 521b. The angle θ1 between the vertical portion 521a and each of the upper surfaces 511b and 512b of the supports 511 and 512 may be a right angle, and the angle between the sloping portion 521b and each of the upper surfaces 511b and 512b of the supports 511 and 512 may be an obtuse angle. The angle θ2 between a rear surface of the projecting wall 522 that faces the rear part 81 of the housing 80 and each of the upper surfaces 511b and 512b of the supports 511 and 512 may be an acute angle. Accordingly, even when the light guide plate 36 is bent rearwards, the projecting wall 52 may support the light guide plate 36. The projecting wall supporting surface 521 may be referred to as a “front surface 521” of the projecting wall 52.

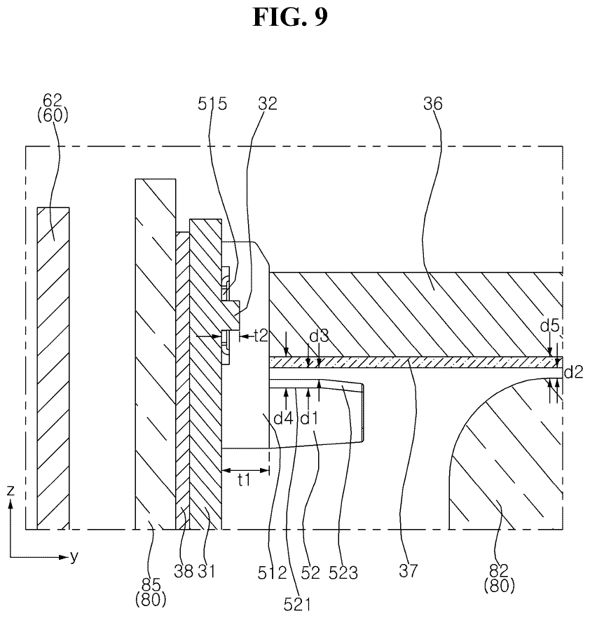

Referring to FIG. 9, the substrate 31 may be disposed closer to the front end of the side part 85 than to the rear end of the side part 85, and a vertical pad 38 may be disposed between the substrate 31 and the side part 85. The plurality of light sources 32 may be disposed closer to the front end of the side part 85 than to the rear end of the side part 85. The vertical pad 38 may be disposed between the substrate 31 and the side part 85 and may be coupled to the substrate 31 and the side part 85. The vertical pad 38 may have adhesive ability. Consequently, the heat generated from the plurality of light sources 32 may be easily transmitted to the side part 85 through the substrate 31 and the vertical pad 38. The vertical pad 38 may include a silicone-based material. The vertical pad 38 may be referred to as a “radiating pad”.

The light sources 32 may face one side of the light guide plate 36, that is, the lower side of the light guide plate 36. Each of the light sources 32 may be an LED and may be operated by receiving power from a power supply (not shown) through the substrate 31. The light sources 32 may be arranged along the central line of the lower side of the light guide plate 36. The central line may extend through the center of the lower side in a rightward-and-leftward direction.

The thickness t2 of the light source 32 disposed on the substrate 31 may be less than the thickness t1 of each of the supports 511 and 512 of the spacer 50. Here, the thickness t2 of the light source 32 may mean the distance t2 between the substrate 31 and the upper surface of the light source 32 that faces the lower side of the light guide plate 36, and the thickness t1 of each of the supports 511 and 512 may mean the distance t1 between the substrate 31 and each of the upper surfaces 511b and 512b of the supports 511 and 512. Accordingly, the upper surface of the light source 32 may be spaced apart from the lower side of the light guide plate 36, and the supports 511 and 512 may protect the light source 32 by preventing collision between the light source 32 and the light guide plate 36.

Referring to FIGS. 5 and 9 together, a pad 523 may be attached to the projecting wall supporting surface 521. The pad 523 may be made of an elastic material and may serve as a buffer between the light guide plate 36 and the reflective sheet 37 and the projecting wall 52.

The distance d1 between the projecting wall supporting surface 521 and the reflective sheet 37 may be equal to or greater than the distance d2 between the projection 82 of the housing 80 and the reflective sheet 37. The distance d3 between the front surface of the pad 523 and the reflective sheet 37 may be equal to greater than the distance d2 between the projection 82 of the housing 80 and the reflective sheet 37. The distance d4 between the projecting wall supporting surface 521 and the light guide plate 36 may be equal to or greater than the distance d5 between the projection 82 of the housing 80 and the light guide plate 36. Accordingly, the projecting wall supporting surface 521 may be spaced apart from the light guide plate 36 and/or the reflective sheet 37 by a predetermined distance. In a hot and humid environment, the light guide plate 36 and/or the reflective sheet 37 may expand, and the lower end of the light guide plate 36 and/or the reflective sheet 37 may be bent. In this case, because the projecting wall supporting surface 521 supports the rear surface of the light guide plate 36 or the reflective sheet 37, it is possible to prevent misalignment between the lower side of the light guide plate 36 and the light source 32.

The pad 37a, which is disposed between the projection 82 of the housing 80 and the reflective sheet 37, may prevent the rear side of the reflective sheet 37 from being scratched by the projection 82. One end of the pad 37a may in contact with the reflective sheet 37 while the opposite surface of the pad 37a may be in contact with the projection 82.

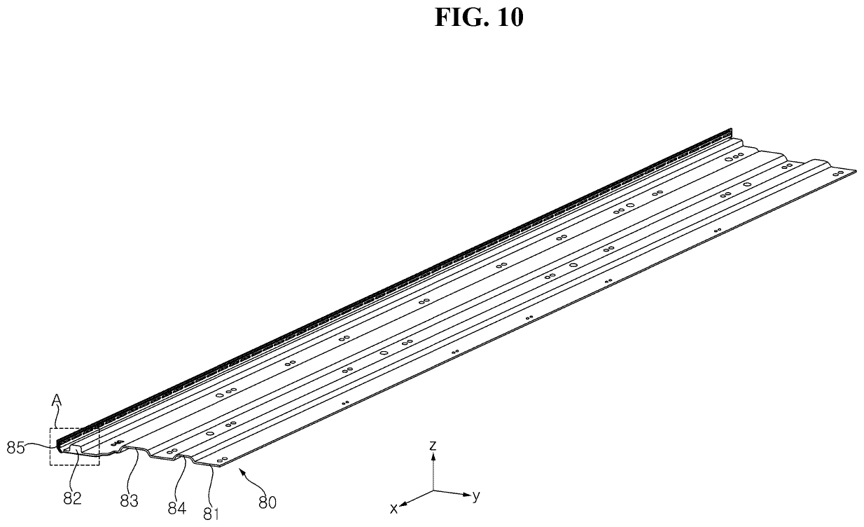

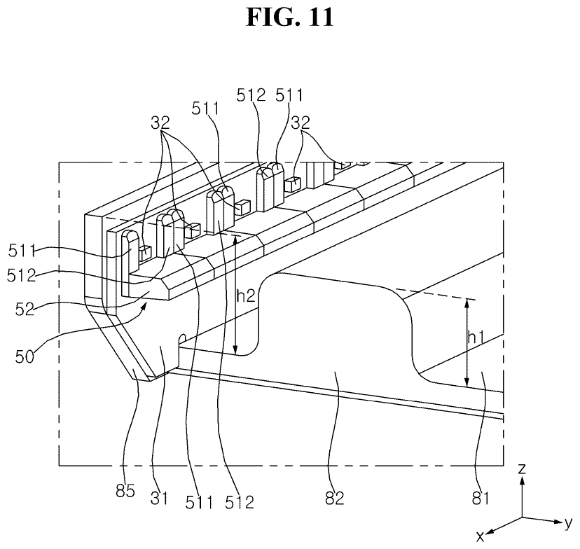

Referring to FIGS. 10 and 11, the housing 80 may extend in a rightward-and-leftward direction. The housing 80 may be disposed adjacent to the lower side of the frame 60 (see FIG. 5). The height h2 of the side part 85 may be greater than the height h1 of the projection 82 in the forward-and-rearward direction. Here the height h2 of the side part 85 may mean the length h2 from the rear part 81 of the housing 80 to the front end of the side part 85, and the height h1 of the projection 82 may mean the length h1 from the rear part 81 to the front end of the projection 82.

Pressed portions 83 and 84 may be formed by pressing the rear surface of the housing 80 forwards. The pressed portions 83 and 84 may be opposed to the side part 85 with the projection 82 interposed therebetween.

The substrate 31 may be disposed between the side part 85 and the projection 82 and may be coupled to the side part 85. The substrate 31 may be spaced apart from the projection 82 downwards. The substrate 31 may extend along the side part 85. For example, the substrate 31 may be an MCPCB (Metal Core Printed Circuit Board).

The plurality of light sources 32 may be disposed on the substrate 31 between the substrate 31 and the projection 82. The plurality of light sources 32 may be spaced apart from each other in a lengthwise direction, that is, in a rightward-and-leftward direction. The plurality of light sources 32 may be arranged in a line in a rightward-and-leftward direction.

Referring to FIGS. 6 and 11, each of the plurality of light sources 32 may be disposed between the first support 511 and the second support 512, and the bridge 513 and the projecting wall 52 may be disposed behind the light source 32. The spacer 50 may include a plurality of spacers 50. The plurality of spacers 50 may be disposed in a line in the lengthwise direction, that is, in a rightward-and-leftward direction. Among two adjacent spacers 50, the second support 512 of the left space 50 and the first support 511 of the right spacer 50 may face each other, and the second support 512 of the left spacer 50 and the first support 511 of the right spacer 50 may be disposed in parallel between two adjacent light sources 32. The vertical portions 521a of the projecting walls 52 of the plurality of spacers 50 may be disposed on the same plane.

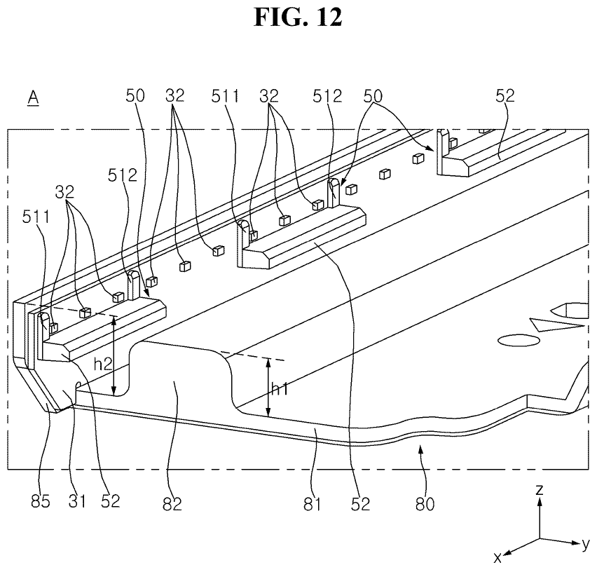

Referring to FIGS. 6 and 12, in another embodiment, the plurality of light sources 32 may constitute a plurality of groups of light sources. For example, each of the groups of light sources may include three light sources 32. One group of light sources 32 may be disposed between the first support 511 and the second support 512 of the spacer 50. The spacer 50 may include a plurality of spacers 50. The plurality of spacers 50 may be arranged in a line in the lengthwise direction of the substrate 31. Two adjacent spacers 50 may be spaced apart from each other in the lengthwise direction of the substrate 31, and at least one light source 32 may be disposed between the two adjacent spacers 50.

Specifically, in each of the plurality of spacers 50, one group of light sources 32 may be disposed between the first support 511 and the second support 512. Among two adjacent spacers 50, the second support 512 of the left spacer 50 may be spaced leftwards apart from the second support 511 of the right spacer 50, and at least one, for example, three light sources 32 may be disposed between the second support 512 and the left spacer 50 and the first spacer 511 of the right spacer 50.

The plurality of spacers 50 may be spaced apart from each other in regular intervals in a rightward-and-leftward direction. The number of light sources 32 disposed between the first support 511 and the second support 512 of one spacer 50 may be equal to the number of light sources 32 disposed between the first support 511 and the second support 512 of any other spacer 50.

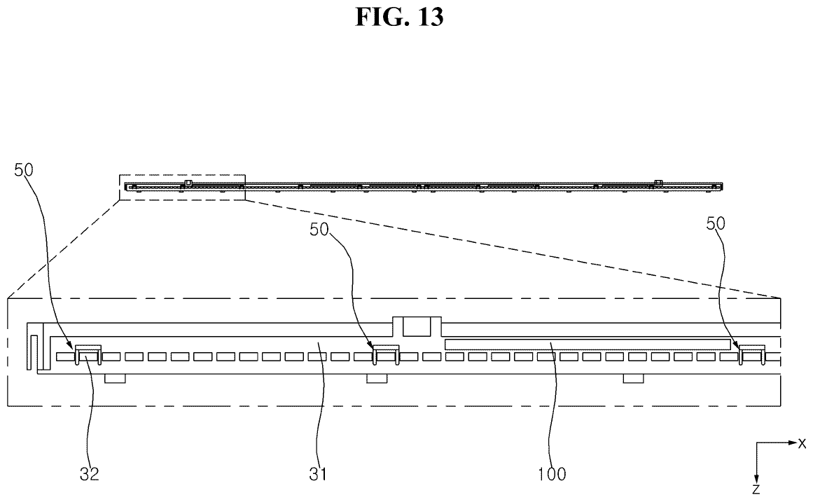

Referring to FIGS. 6 and 13 together, in still another embodiment, one of the light sources 32 may be disposed between the first support 511 and the second support 512 and may be disposed in front of the bridge 513 and the projecting wall 52. The spacer 50 may include a plurality of spacer 50 which are spaced apart from each other in the lengthwise direction of the substrate 31, that is, in a rightward-and-leftward direction. A plurality of light sources 32 may be disposed between two of the plurality of spacers 50. The number of spacers 50 disposed on the substrate 31 may be greater than the number of light sources 32 disposed on the substrate 31.

A subsidiary pad 100 may be disposed between two of the spacers 50. The subsidiary pad 100 may be disposed behind the plurality of light sources 32 and may be disposed between the projecting walls 52 of two adjacent spacers 50. The subsidiary pad 100 may prevent the light guide plate 36 (see FIG. 9) from expanding and being bent rearwards in a high temperature and/or high humidity environment. In a high temperature and/or high humidity environment, the light guide plate 36 (see FIG. FIG. 9) may expand and/or be bent, and the light guide plate 36 (see FIG. 9) may rotate the projecting wall 52 of the spacer 50. The subsidiary pad 100 may support the projecting wall 52 of the spacer 50 to prevent the light guide plate 36 (see FIG. 9) from being misaligned with the light source 32. The front end of the subsidiary pad 100 may be disposed behind the projecting wall supporting surface 521 in a forward-and-rearward direction or may be substantially flush with the projecting wall supporting surface 521.

The light sources 31 and/or the spacers 50 may be symmetrically disposed in a rightward-and-leftward direction based on the center of the substrate 31. The spacers 50, which are disposed to any one of right side and left side of the center or the substrate 31, may be spaced apart from each other by regular intervals.

Specifically, six spacers 50 may be disposed on the right side of the center of the substrate 31 and may be spaced apart from each other in regular intervals. The region of substrate 31 positioned to the right side of the center of the substrate 31 may be divided into five regions defined by the six spacers 50. Each of the five regions may be defined as the region between two adjacent spacers 50. The subsidiary pad 100 may be disposed in each of the second, fourth and fifth regions among the five regions based on the right end.

Six spacers 50 may be disposed to the left side of the center of the substrate 31 and may be spaced apart from each other in regular intervals. The region of substrate 31 positioned to the left side of the center of the substrate 31 may be divided into five regions defined by the six spacers 50. Each of the five regions may be defined as the region between two adjacent spacers 50. The subsidiary pad 100 may be disposed in each of the second, fourth and fifth regions among the five regions based on the left end.

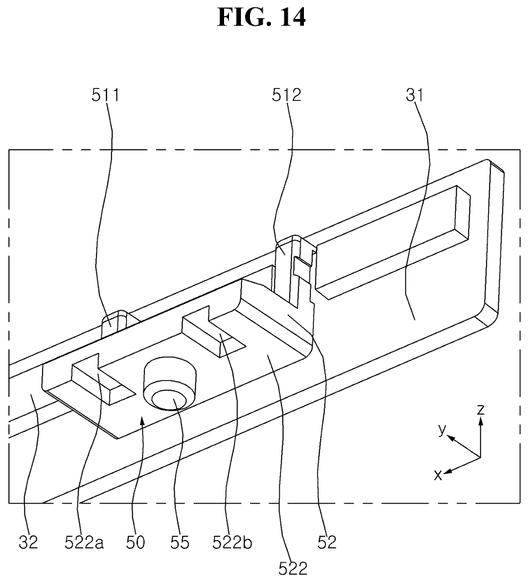

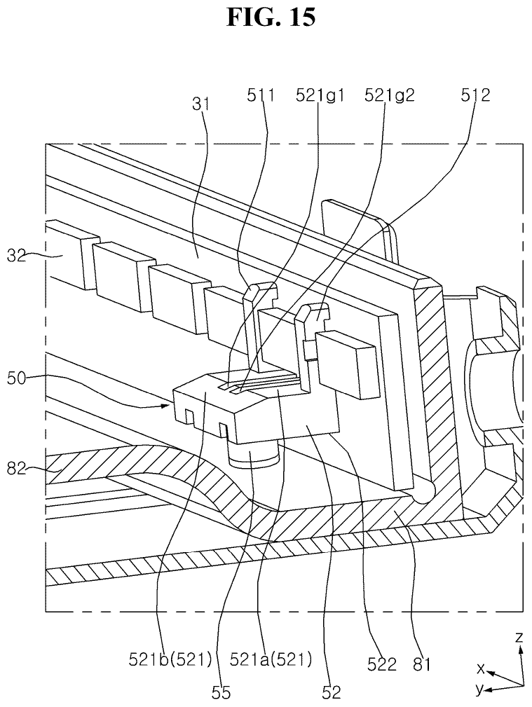

Referring to FIGS. 14 and 15, the spacer 50 may include a pillar 55 which extends rearwards from the projecting wall 52. The pillar 55 may extend rearwards from the center of the rear surface 522 of the projecting wall 52. Specifically, the pillar 55 may have the form of a cylinder. The pillar 55 may have the form of a cylinder having a diameter ranging from 1 mm to 4 mm and a height ranging from 0.7 mm to 2.8 mm. The pillar 55 may be referred to as a “support 55”, a “column 55”, a “supporting boss 55”, or a “projection 55”.

The projecting wall 52 may include grooves 522a and 522b depressed forwards from the rear surface 522 of the projecting wall 52. The grooves 522a and 522b formed in the rear surface 522 of the projecting wall 52 may include a first groove 522a and a second groove 522b spaced rightwards apart from the first groove 522a. The pillar 55 may be disposed between the first groove 522a and the second groove 522b.

Furthermore, the projecting wall 52 may include grooves 521g1 and 521g2 depressed rearwards from the projecting wall supporting surface 521. The grooves 521g1 and 521g2 may be formed both in the vertical portion 521a and the sloping portion 521b of the projecting wall 52. The grooves 521g1 and 521g2 may include a third groove 521g1 and a fourth groove 521g2 spaced rightwards apart from the third groove 521g1.

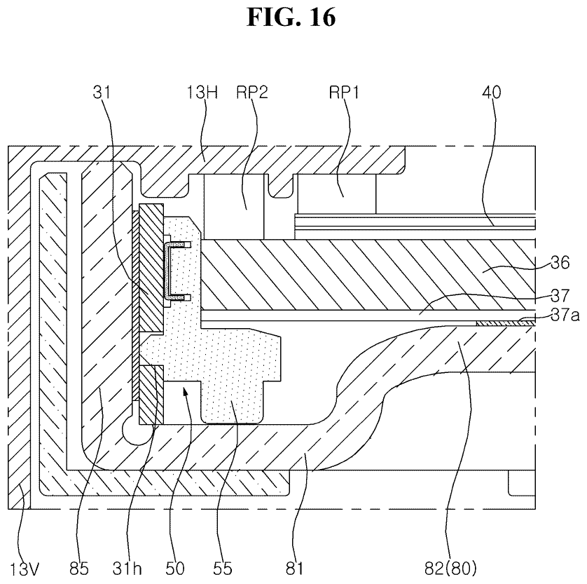

Referring to FIGS. 15 and 16, the pillar 55 may be disposed adjacent to the rear part 81 of the housing 80 positioned behind the projecting wall 52. Specifically, the pillar 55 may be in contact with the rear part 81, thereby supporting the projecting wall 520 to prevent the projecting wall 52 from being pushed rearwards.

As a result, even when the light guide plate 36 expands and/or is bent and thus pushes the projecting wall 51 in a high temperature and/or high humidity environment, the spacer 50 cannot be rotated rearwards or be separated from the substrate 31, and the spacer 50 is capable of preventing the light guide plate 36 from being bent rearwards and being misaligned with the light source 32.

The front surface of the light guide plate 36 may be supported by the horizontal portion 13H of the guide panel 13 and the pads RP1 and RP2 disposed between the horizontal portion 13H and the light guide plate 36, and the pads RP1 and RP2 may be disposed adjacent to the lower end of the light guide plate 36. Consequently, the horizontal portion 13H and the pads RP1 and RP2 are capable of preventing the light guide plate 36 from being bent forwards.

The rear surface of the light guide plate 36 may be supported by the projection 82 of the housing 80. The projection 82 of the housing 80 may be disposed so as to be spaced upwards apart from the lower end of the light guide plate 36, and the projecting wall 52 of the spacer 50 may be disposed adjacent to the lower end of the light guide plate 36 so as to support the rear surface of the light guide plate 36.

Consequently, it is possible to prevent the light guide plate from being bent forwards or rearwards and thus being misaligned with the light source 32 even in high temperature and/or high humidity environment.

Referring to FIGS. 1 to 16, the display device 1 according to an aspect of the present disclosure may include: a display panel 10; a frame 60 disposed behind the display panel 10; a light guide plate 36 disposed between the display panel 10 and the frame 60; a housing 80 including a rear part 81 disposed between the light guide plate 36 and the frame 60 and configured to support the light guide plate 36 and a side part 85 intersecting the rear part 81 and facing one side of the light guide plate 36; a substrate 31 disposed between the side part 85 and the one side of the light guide plate 36 and coupled to the side part 85; a light source 32 disposed on the substrate 31 and providing light to the one side of the light guide plate 36; and a spacer 50 including the supports 511 and 512 disposed around the light source 32 and coupled to the substrate 31 and the projecting wall 52 extending from the supports 511 and 512 and disposed behind the light guide plate 36.

The thickness of the supports 511 and 512 of the spacer 50 may be greater than the thickness of the light source 32.

The housing 80 may further include the projection 82 projecting forwards from the rear part 81 to support the rear surface of the light guide plate 36.

A distance between the projection 82 of the housing 80 and the light guide plate 36 may be less than the distance between the projecting wall 52 of the spacer 50 and the light guide plate 36.

The display device may further include a reflective sheet 37 disposed between the light guide plate 36 and the projection 82 of the housing 80, and the reflective sheet 37 may be in contact with the projection 82 of the housing 80 and may be disposed adjacent to the projecting wall 52 of the spacer 50.

The spacer 50 may further include protrusions 53 and 54 projecting in the opposite direction of the projection 52 based on the supports 511 and 512, and the substrate 31 may include the holes 31h into which the protrusions 53 and 54 of the spacer 50 are inserted.

The light source 32 may include a plurality of light sources 32 which are spaced apart from each other, the supports 511 and 512 of the spacer 50 may include the first support 511 and the second support 512 spaced apart from the first support 511, and at least one of the plurality of light sources 32 may be disposed between the first support 511 and the second support 512.

The spacer 50 may further include a bridge 513 connecting the end of the first support 511 to the end of the second support 512 and in contact with the substrate 31, and the projecting wall 52 of the spacer 50 may project from the first support 511, the second support 512 and the bridge 513.

At least a portion of a projecting wall supporting surface 521, which faces the light guide plate 36, may be perpendicular to one surface 511b and 512b of the support 511 and 512 of the spacer 50 which faces the one side of the light guide pate 36, and wherein a rear surface 522 of the projecting wall 52, which faces the rear part 81 of the housing 80, may define an acute angle with respect to the one surface 511b and 512b of the support 511 and 512.

The spacer 50 may further include the pillar 55 extending rearwards from the projecting wall 52.

The support 511, 512 of the spacer 50 may comprise: a depressed portion 511a, 512a depressed from one surface of the support 511, 512 that faces the substrate 31; and a damper 514, 515 projecting toward the substrate 31 from the depressed portion 511a, 512a.

The support 511, 512 of the spacer 51 may further comprise a first groove 511ah1, 512ah1 and a second groove 511ah2, 512ah2 which are formed in the depressed portion 511a, 512a and which are spaced apart from each other, and the damper 514, 515 may comprise: a first part 5141, 5151 having a plate shape which faces the substrate 31; a second part 5142, 5152 which is bent toward the depressed portion 511a, 512a from the first part 5141, 5151 and which is inserted in the first groove 511ah1, 512ah1 ; and a third part 5143, 5153 which is spaced apart from the second part 5142, 5152 and which is bent toward the depressed portion 511a, 512a from the first part 5141, 5151 and which is inserted into the second groove 511ah2, 512ah2.

An end of the pillar 55 may be disposed adjacent to the rear part 81.

The spacer 50 may further include a pad 523 attached to the projecting wall supporting surface 521 which faces the light guide plate 36 of the projecting wall 52.

The display device may further include the optical sheet 40 disposed between the display panel 10 and the light guide plate 36, and the distance between the first surfaces 511b and 512b of the supports 511 and 512 which face the light guide plate 36 and the optical sheet 40 may be greater than the distance between the first surfaces 511b and 512b of the supports 511 and 512 and the end of the projecting wall 52.

The light source 32 may be aligned with the central line of the one side of the light guide plate 36.

The light source 32 may be an LED, the housing 80 may include a metal material, and the substrate 31 may be an MCPCB (Metal Core Printed Circuit Board).

The display device 1 according to an aspect of the present disclosure may include a display panel 10; a light guide plate 36 disposed behind the display panel 10; a housing 80 including a rear part 81 disposed behind the light guide plate 36 and configured to support the light guide plate 36 and a side part 85 intersecting the rear part 81 and facing one side of the light guide plate 36; a substrate 31 disposed between the side part 85 and the one side of the light guide plate 36 and coupled to the side part 85; a plurality of light sources 32 disposed on the substrate 31 and providing light toward the one side of the light guide plate 36; and a spacer 50 including the base 51 including the legs 511 and 512 disposed around the light source 32 and in contact with the substrate 31 and the rack 52 projecting from the base 51 and disposed behind the light guide plate 36.

A distance between the substrate 31 and first surfaces 511b and 512b of the legs 511 and 512 which face the light guide plate 36 may be greater than the thickness of the plurality of light sources 32, and the rack 52 of the spacer 50 may be disposed adjacent to the light guide plate 36.

The legs 511 and 512 may include the first leg 511 disposed between the plurality of light sources 32 and the second leg 512 spaced apart from the first leg 511 and disposed between the plurality of light sources 32, and at least one of the plurality of light sources 32 may be disposed between the first leg 511 and the second leg 512.

The spacer 50 may further include protrusions 53 and 54 projecting from the base 51 in the opposite direction of the rack 52, and the substrate 31 may include the holes 31h into which the protrusions 53 and 54 of the spacer 50 are inserted.

The display device may further include a guide panel 13 including a vertical portion 13V covering the side part 85 and a horizontal portion 13H intersecting the vertical portion 13V and covering at least a portion of the front surface of the light guide plate 36, wherein the housing 80 may further include the projection 82 projecting forwards from the rear part 81 may be supported at the rear side thereof by the projection 82 of the housing 80 and at the front side thereof by the pads RP1 and RP2 attached to the horizontal portion 13H of the guide panel 13.

The effects of the display device according to the present disclosure will be described.

According to at least one of the embodiments of the present disclosure, it is possible to provide a structure in which the light source of the backlight unit is spaced apart from the light guide plate.

According to at least one of the embodiments of the present disclosure, it is possible to provide a structure configured to prevent the light source of the backlight unit from colliding with the light guide plate.

According to at least one of the embodiments of the present disclosure, it is possible to provide a structure configured to stably support the light guide plate.

According to at least one of the embodiments of the present disclosure, it is possible to prevent the light source of the backlight unit from being misaligned with the light guide plate.

According to at least one of the embodiments of the present disclosure, it is possible to provide a structure configured to prevent the light guide plate from being bent.

The additional scope of applicability of the present disclosure will be apparent from the above detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

Certain embodiments or other embodiments of the disclosure described above are not mutually exclusive or distinct from each other. Any or all elements of the embodiments of the disclosure described above may be combined with each other in configuration or function.

For example, a configuration “A” described in one embodiment of the disclosure and the drawings and a configuration “B” described in another embodiment of the disclosure and the drawings may be combined with each other. That is, even if the combination of the configurations is not explicitly described, the combination is possible except in the case where it is stated that the combination is impossible.

Although embodiments have been described with reference to a number of illustrative embodiments thereof, it should be understood that numerous other modifications and embodiments that fall within the scope of the principles of this disclosure can be devised by those skilled in the art. More particularly, various variations and modifications are possible in the component parts and/or arrangements within the scope of the disclosure, the drawings and the appended claims. In addition to variations and modifications in the component parts and/or arrangements, alternative uses will also be apparent to those skilled in the art.

What is claimed is:

1. A display device comprising:
a display panel;
a frame disposed behind the display panel;
a light guide plate disposed between the display panel and the frame;
a housing comprising a rear part disposed between the light guide plate and the frame and configured to support the light guide plate and a side part intersecting the rear part and facing one side of the light guide plate;
a substrate disposed between the side part and the one side of the light guide plate and coupled to the side part;
a light source disposed on the substrate and providing light toward the one side of the light guide plate; and
a spacer comprising a support disposed around the light source and coupled to the substrate and a projecting wall extending from the support and disposed behind the light guide plate.

2. The display device of claim 1, wherein a thickness of the support of the spacer is greater than a thickness of the light source.

3. The display device of claim 1, wherein the housing further comprises a projection projecting forwards from the rear part and supporting a rear surface of the light guide plate.

4. The display device of claim 3, wherein a distance between the projection and the light guide plate is less than a distance between the projecting wall of the spacer and the light guide plate.

5. The display device of claim 4, further comprising a reflective sheet disposed between the light guide plate and the projection of the housing,
wherein the reflective sheet is in contact with the projection of the housing and is disposed adjacent to the projecting wall of the spacer.

6. The display device of claim 1, wherein the spacer further comprises a protrusion projecting from the support in an opposite direction to the projecting wall, and
wherein the substrate has a hole into which the protrusion of the spacer is inserted.

7. The display device of claim 1, wherein:
the light source comprises a plurality of light sources spaced apart from each other,
the support of the spacer comprises:
a first support; and
a second support spaced apart from the first support, and
at least one of the plurality of light sources is disposed between the first support and the second support.

8. The display device of claim 7, wherein the spacer further comprises a bridge connecting an end of the first support to an end of the second support and in contact with the substrate, and
wherein the projecting wall of the spacer projects from the first support, the second support and the bridge.

9. The display device of claim 1, wherein at least a portion of a projecting wall supporting surface which faces the light guide plate is perpendicular to one surface of the support of the spacer which faces the one side of the light guide plate, and
wherein a rear surface of the projecting wall which faces the rear part of the housing defines an acute angle with respect to the one surface of the support.

10. The display device of claim 1, wherein the spacer further comprises a pillar extending rearwards from the projecting wall.

11. The display device of claim 10, wherein an end of the pillar is disposed adjacent to the rear part.

12. The display device of claim 1, wherein the support of the spacer comprises:
a depressed portion depressed from one surface of the support that faces the substrate; and
a damper projecting toward the substrate from the depressed portion.

13. The display device of claim 12, wherein the support of the spacer further comprises a first groove and a second groove which are formed in the depressed portion and which are spaced apart from each other, and
the damper comprises:
a first part having a plate shape which faces the substrate;
a second part which is bent toward the depressed portion from the first part and which is inserted in the first groove; and
a third part which is spaced apart from the second part and which is bent toward the depressed portion from the first part and which is inserted into the second groove.

14. The display device of claim 1, wherein the spacer further comprises a pad attached to a projecting wall supporting surface which faces the light guide plate of the projecting wall.

15. The display device of claim 1, further comprising an optical sheet disposed between the display panel and the light guide plate, and
a distance between one surface of the support that faces the light guide plate and the optical sheet is greater than a distance between the one surface of the support and an end of the projecting wall.

16. A display device comprising:
a display panel;
a light guide plate disposed behind the display panel;
a housing comprising a rear part disposed behind the light guide plate and configured to support the light guide plate and a side part intersecting the rear part and facing one side of the light guide plate;
a substrate disposed between the side part and the one side of the light guide plate;
a plurality of light sources disposed on the substrate and providing light toward the one side of the light guide plate; and
a spacer comprising a base comprising a leg disposed around the plurality of light sources and in contact with the substrate, and a rack projecting from the base and disposed behind the light guide plate.

17. The display device according to claim 16, wherein a distance between the substrate and one surface of the leg that faces the light guide plate is greater than a thickness of the plurality of light sources, and
wherein the rack of the spacer is disposed adjacent to the light guide plate.

18. The display device of claim 17, wherein the leg comprises:
a first leg disposed between the plurality of light sources; and
a second leg spaced apart from the first leg and disposed between the plurality of light sources, and
wherein at least one of the plurality of light sources is disposed between the first leg and the second leg.

19. The display device of claim 16, wherein the spacer further comprises a protrusion projecting from the base in an opposite direction to the rack, and
wherein the substrate has a hole into which the protrusion of the spacer is inserted.

20. The display device of claim 19, further comprising a guide panel comprising a vertical portion covering the side part and a horizontal portion intersecting the vertical portion and covering at least a portion of the light guide plate,
wherein the housing further comprises a projection projecting forwards from the rear part, and
the light guide plate is supported at a rear side thereof by the projection and at a front side thereof by a pad attached to the horizontal portion of the guide panel.
